(19) United States
(12) Patent Application Publication
(10) Pub. No.: US 2025/0333365 A1
(43) Pub. Date: Oct. 30, 2025

(54) SYSTEM AND METHODS FOR ADDITIVELY MANUFACTURING ENERGETIC PARTICLES

(71) Applicant: Oqab Dietrich Induction Inc., Kitchener (CA)

(72) Inventors: Haroon B. Oqab, Kitchener (CA); George B. Dietrich, Kitchener (CA); John Z Wen, Waterloo (CA); Jean-pierre Hickey, Waterloo (CA); Anqi Wang, Waterloo (CA); Connor J. MacRobbie, Kitchener (CA); Alex Baranovsky, Kitchener (CA)

(21) Appl. No.: 18/841,248

(22) PCT Filed: Feb. 27, 2023
(86) PCT No.: PCT/CA2023/050247

§ 371 Date: Aug. 23, 2024

Related U.S. Application Data
(60) Provisional application No. 63/314,328, filed on Feb. 25, 2022.

(51) Int. Cl. C06B 45/04; B33Y 10/00; B33Y 30/00; B33Y 40/10; B33Y 40/20; B33Y 80/00; C01B 32/184; C01B 32/198; C06B 21/00

(52) U.S. Cl. CPC C06B 45/04; B33Y 10/00; B33Y 30/00; B33Y 40/10; B33Y 40/20; B33Y 80/00; C01B 32/184; C01B 32/198; C06B 21/0075

(57) ABSTRACT

A system and methods for additively manufacturing energetic particles such as polymer-free nanothermite aerogels are provided. An ink containing graphene oxide (GO), Al, and Bi₂O₃ nanoparticles in propylene carbonate is prepared. The method includes in-situ reduction of graphene oxide (GO), by ethylenediamine, during extrusion and printing of the ink onto a substrate with a simple printing system. The printed aerogels include reduced GO as a porous scaffold for the aerogel with Al and Bi₂O₃ clusters embedded therein. The linear burning rate of the printed aerogels reached a higher rate (10 m/s) that reported for typical polymer-assisted 3D printed nanothermite products. Also provided is a framework for optimizing a nanothermite fuel grain structure to match a desired combustion profile. The framework was used to model optimal fuel layer thicknesses, radii and bum rates for simple thrust, complex thrust and pressure matching cases.

### TECHNICAL FIELD

The embodiments disclosed herein relate to energetic particles, and, in particular to a system and methods for additive manufacturing energetic particles, such as polymer-free nanothermite aerogels.

### INTRODUCTION

Energetic particles such as thermite and/or metallic materials and/or fuels can be used for heating and combustion as an energy source to meet energy demands on Earth, and in space. Thermite materials have been used in application for railway construction, mining and defense industries. In general, thermite materials consist of two distinct components: a fuel, and an oxidizer. Reducing metals and metalloids, such as aluminum (Al), magnesium (Mg), silicon (Si), are usually chosen to be the fuel component due to their large enthalpy change during combustion. Oxidizers, on the other hand, are typically metal oxides, halides, and oxyanion salts. Al-based thermite is the most commonly used thermite in this family due to its abundance, ease of production, and extremely high theoretical combustion enthalpy of 31 kJ/g. Significant heat is released during the redox reactions between the fuel, oxidizer and intermediates, leading to its many applications in propulsion, pyrotechnics, welding, and so on.

Nanothermites, also known as metastable intermolecular composites, consist of a nano-scale fuel or oxidizer component, or both. Nanothermites show a much-enhanced burning rate due to their larger surface contact between fuel and oxidizer particles and amplified roles of the reactive interface accompanied by a large surface to volume ratio. Intensive research efforts have focused on the development of nanothermites with various compositions and micro-/meso-structures to further enhance their reaction rate, leading to optimized burning velocity and combustion chamber pressurization rate. However, real-world applications of nanothermite materials are still very limited due to some critical disadvantages of nanothermite materials, including difficulties in reactivity control, degree of combustion completion, and issues associated with safe production, handling, and transportation. Lack of controllability in reactivity is caused by multi-scale physics involving the phase separation during synthesis, reactive sintering of Al nanoparticles during combustion, and formation and growth of an inert alumina shell on the surface of Al nanoparticles. Additionally, nanothermites exhibit extreme sensitivity to external stimuli, such as electrostatic discharge, friction, and mechanical shock.

Graphene and functionalized graphene have been recently utilized as additives in nanothermite composites. While their participative roles in the thermite reaction are still debatable, the exfoliated 2D sheets provide additional surface area for both Al and metal oxide nanoparticles to assemble on, and the electrically conductive graphene and reduced graphene oxide (rGO) may reduce the risk of accidental ignition by electrostatic discharge.

Additive manufacturing has been a critical innovation in many industries in recent decades due to its versatility in prototyping, rapid tooling, and instant manufacturing. As one of the most important methods to facilitate additive manufacturing, extrusion-based printing, or direct ink writing, has been found promising in fabricating multi-components structures and developing controlled mechanical and physical properties. It is also considered a crucial tool for the development of novel and flexible thermite-based architected reactive interfaces and structures. To obtain a good “ink” for additive manufacturing and or printing nanothermites with desirable viscosity, distribution and improved structural integrity after drying, polymers are commonly used as an additive, usually leading to a relatively low burning rate of the printed solid products.

Shen et al. used a polymer combination of hydroxypropyl methylcellulose, nitrocellulose, and polystyrene at 10 wt % total to print Al—CuO nanothermite with a maximum linear burning rate, which is a common parameter to describe the combustion velocity of nanothermites, of 25 cm/s (Shen, H. et al., “Combustion of 3D printed 90 wt % loading reinforced nanothermite,” Combust. Flame, 215 (2020) 86-92). Mao et al. utilized fluororubber F2311 at 5-25 wt %, and obtain an Al—CuO printed nanothermite reaching its highest linear burning rate at 1.5 m/s (Mao, L., et al., “3D Printing of Micro-Architected Al/CuO-Based Nanothermite for Enhanced Combustion Performance,” Adv. Eng. Mater., 21 (2019) 1900825).

Additive manufacturing (e.g., 3D printing) is critical for safe and customizable production in future applications of nanothermite materials. Presently, polymers are usually used to adjust the rheology of the ink and support the final structure of the printed nanothermite products, which vastly limits the energetic performance of the printed material. Certain designs, such as hollow structures, must be considered and specifically fabricated to increase the burning rate of the printing nanothermite beyond 10 m/s. Accordingly, there is a need for novel additive manufacturing systems and methods for polymer-free nanothermite aerogel fuel grains.

The conceptual design stage of rocket propulsion systems aims to align the mission requirements to the preliminary design considerations of the engine within the specified constraints of the problems. In solid or hybrid rocket engines, the parametric design space is particularly important, as propellant characteristics, grain structure, and combustion chamber geometries can be independently varied for particular missions. Furthermore, as the combustion advances and the fuel regresses, the thermodynamic characteristics of the engine change in time as the total combustion chamber volume increases and the normalized surface area changes. The high-dimensionality of this problem has motivated the development of frameworks to match the mission profiles to the propulsion system design.

Depending on the focus of the conceptual design, some frameworks propose a holistic consideration for the optimization of the propulsion system for the ascent trajectory (Federici, L., et al., “Integrated optimization of first stage SRM and ascent trajectory of multistage launch vehicles,” Journal of Spacecraft and Rockets, vol. 58, no. 3, pp. 786-797, 2021), including the consideration for the non-linear aerodynamic forces. Other works seek to optimize the fuel grain geometry to the meet the desired thrust profile (Oh, S. H., et al., “Study of hybrid optimization technique for grain optimum design,” International Journal of Aeronautical and Space Sciences, vol. 18, no. 4, pp. 780-787, 2017), feed systems and structural modeling (Adami, A., et al., “A new approach in multidisciplinary design optimization of upper-stages using combined framework,” Acta Astronautica, vol. 114, pp. 174-183, 2015), or conduct performance matching optimization (Zeping, W., et al., “Solid rocket motor design employing an efficient performance matching approach,” Proceedings of the Institution of Mechanical Engineers, Part G: Journal of Aerospace Engineering, vol. 233, no. 11, pp. 4052-4065, 2019). In many of these works, the propellant characteristics, such as burn rate, are not considered to be an independent variable given the strong interdependence of the regression rate, heat release and erosive properties of the propellant.

Existing methodologies often rely on variational optimization approaches to determine the optimal geometric parameters of the fuel grain; these optimizations are constrained by the physics of the problem, while seeking to minimize the overall mass and/or total cost. Although, often for complex fuel grains, it is the manufacturability which imposes the greatest constraint on the optimization problem.

Existing works have sought to apply optimization techniques to more complex geometrical cases with additional considerations (Johannsson, M., “Optimization of Solid Rocket Grain Geometries,” 2012). Methodologies such as the Level set-based burn back analysis uses a level set approach to follow the change in topology of the burning SRM (Wang, D. H., et al., “An integrated framework for solid rocket motor grain design optimization,” Proceedings of the Institution of Mechanical Engineers, Part G: Journal of Aerospace Engineering, vol. 228, no. 7, pp. 1156-1170, 2014). Most of these optimization techniques rely on a continuous, bounded range for each parameter being optimized. These techniques also require the designer to properly assign bounds to the problem such that the program will come to an optimal solution in a timely manner. Some more recent works have proposed machine learning approaches (Oh, S. H., et al., “New design method of solid propellant grain using machine learning,” Processes, vol. 9, no. 6, 2021) or two-component propellant grain optimization (Alazeezi, M., et al., “Two-component propellant grain for rocket motor: Combustion analysis and geometric optimization,” Thermal Science, vol. 26, no. 2 Part B, pp. 1567-1578, 2022) which may be more beneficial to optimizing the fuel grain of solid rocket motors. Ultimately, these constraints limit the ability optimize for more complex thrust profiles.

Recent years have seen drastic changes in solid and hybrid propulsion technology as new propulsion paradigms are taking hold. Recent works have proposed the integration of hypergolic additives based on a metal-organic framework (MOF) (Jobin, O., et al., “Metal-organic frameworks as hypergolic additives for hybrid rockets,” Chemical Science, vol. 13, no. 12, pp. 3424-3436, 2022). Concurrently, new manufacturing processes of solid-state fuels, via additive manufacturing (AM) techniques, are opening up new design opportunities for a novel class of solid and hybrid state propulsion systems.

Historically, the selection of the fuel grain structure represented the optimal approach to achieving a desired thrust-time curve. For a known propellant burn- and regression rate, the imposed grain structure causes a change in area, concomitantly combustion heat release, with time. For example, a tubular grain design (see FIG. 6A, left), results in a progressive (increasing) thrust curve as the burn area increases as the grain regresses towards the outer wall; a star-type fuel grain (see FIG. 6A, right), is needed for a neutral (constant) thrust curve. The design of these grain structures require the use of burn-back models. Furthermore, these complex structures are prone to significant erosive burning, structural integrity issues, and manufacturability constraints.

The new opportunities afforded by AM of energetic fuels, as discussed above, means that the solid and hybrid engine design considerations can shift away from complex geometrical fuel grains to modify the thrust-time curve and move towards new design considerations by functionally grading single- or even multi-fuel propellant engines (see FIG. 6B). By layering various fuels with spatially-varying binder and propellant compositions, it is possible to effectively construct a matching thrust-time profile without the need for complex fuel grains, thus opening new opportunities for novel engine design and optimization considerations.

### SUMMARY

Methods for additive manufacturing energetic particles, such as 3D printing polymer-free nanothermite aerogels and an additive manufacturing system are described. An ink was prepared by dispersing graphene oxide, Al, and Bi₂O₃ nanoparticles in propylene carbonate. Graphene oxide made up 5% to 20% (by mass) in the ink, and nanoparticle loading was varied between 80% to 95%. Graphene oxide was reduced in-situ by ethylenediamine during the printing process. The in-situ reduction and gelation of graphene oxide (GO) to reduced graphene oxide (rGO) by ethylenediamine allows for a straightforward room-temperature 3D printing of nanothermite aerogel with flexible nanoparticle loading using a relatively simple printing system comprising syringe pumps and linear actuators.

The printed rGO/Al/Bi₂O₃ aerogel included a porous structure consisting of interconnected rGO scaffolds and wrapped Al/Bi₂O₃ nanothermite clusters. The nanoparticles showed no sign of phase separation and great homogeneity. The densely packed fuel and oxidizer nanoparticles significantly reduced the reaction temperature and promoted the occurrence of condensed-phase reaction. With a nanoparticle loading over 90%, the material showed a linear burning rate up to 10 m/s, much higher than existing polymer-assisted 3D printed nanothermite composites.

According to some embodiments, there is a method for 3D printing nanothermite aerogels. The method includes in-situ mixing a printable ink comprising nanothermites and graphene oxide, with ethylenediamine, in an extrusion tube to form a gel; extruding the gel onto a substrate; immersing the substrate and the gel thereon into tert-butanol under stirring; and freeze drying the gel to form a nanothermite aerogel.

The method may include preparing the printable ink by: separately dispersing each of the graphene oxide, fuel nanoparticles and oxidizer nanoparticles in propylene carbonate under sonication; mixing the dispersion of fuel nanoparticles and the dispersion of oxidizer nanoparticles with a dispersion of graphene oxide in various concentrations and a plurality of combinations; and resting a resultant mixture.

According to an embodiment, there is an additive manufacturing printing system. The system includes a first syringe containing a printable ink, the ink comprising graphene oxide and a second syringe containing an additive for reducing the graphene oxide. Adjustable syringe pumps drive the first and second syringes. An extrusion tube having an outlet is connected to the first tube for extruding the ink onto a substrate. A needle is connected to the second syringe for injecting the reducing additive into the extrusion tube at a location between the first syringe and the outlet. The printing system includes a stage for mounting the substrate. The stage is movable in a horizontal plane by two linear actuators. In some examples, a third actuator may be added to enable movement in the vertical axis. In other embodiments, butanediamine may be used to reduce the graphene oxide.

According to some embodiments, there are nanothermite aerogels comprising a porous cross-linked scaffold of reduced graphene oxide and a plurality of nanothermite clusters embedded in the porous scaffold. The nanothermite clusters include fuel nanoparticles and oxidizer nanoparticles. The nanothermite aerogels may be formed into energetic materials for combustion for power generation, propulsion and/or construction application.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a flow diagram of a method for polymer-free nanothermite aerogel direct ink printing, according to an embodiment;

FIG. 1B is a diagram of an additive manufacturing system, according to an embodiment;

FIG. 2A is an image of a nanothermite ink before printing, according to an embodiment;

FIG. 2B is an image of a nanothermite gel immediately after printing, according to an embodiment;

FIG. 2C is an image of the nanothermite gel of FIG. 2B during solvent change;

FIG. 2D is an image of the nanothermite gel of FIGS. 2B-2C after freeze drying;

FIG. 2E is an X-ray diffraction spectrum of the dried nanothermite gel shown in FIG. 2D;

FIGS. 3A-3C are scanning electron microscope images of a printed rGO/Al/Bi₂O₃ aerogel, according to an embodiment;

FIGS. 3D-3F are energy dispersive spectroscopy images mapping aluminum, bismuth and carbon, respectively, in the image shown in FIG. 3B;

FIG. 4A is a differentiative scanning calorimetry curves of various nanothermite aerogels during a slow heating process, according to several embodiments;

FIG. 4B is a thermogravimetric analysis of nanothermite aerogels during the slow heating process, according to several embodiments;

FIGS. 5A-5C are video frames showing combustion of nanothermite aerogels, according to several embodiments;

FIG. 6A is a diagram of classical fuel grain geometries;

FIG. 6B is a diagram of a functionally-graded fuel grain geometry;

FIG. 7A is a regressive (simple) thrust profile;

FIG. 7B is a two peaks (complex) thrust profile;

FIG. 7C is a pressure vs. altitude curve for optimal thrust during ascent;

FIG. 8A is an ideal burn velocity profile for simple thrust, according to an embodiment;

FIG. 8B is an optimized simple thrust profile, based on the ideal velocities shown in FIG. 8A;

FIG. 9A is an ideal burn velocity profile for complex thrust, according to an embodiment;

FIG. 9B is an optimized complex thrust profile, based on the ideal velocities shown in FIG. 9A;

FIG. 10A is an ideal burn velocity profile for pressure matching, according to an embodiment; and

FIG. 10B is an optimized pressure profile for pressure matching, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

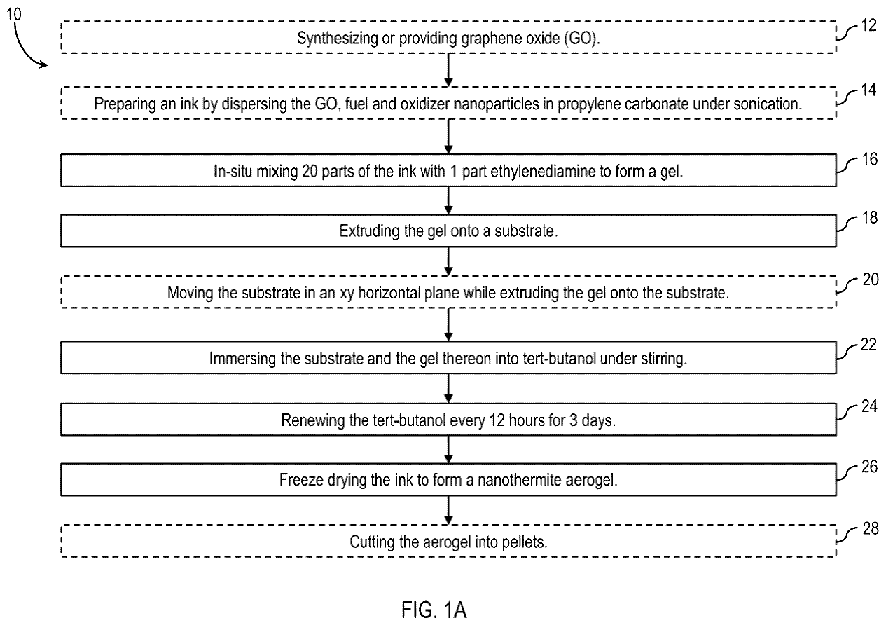

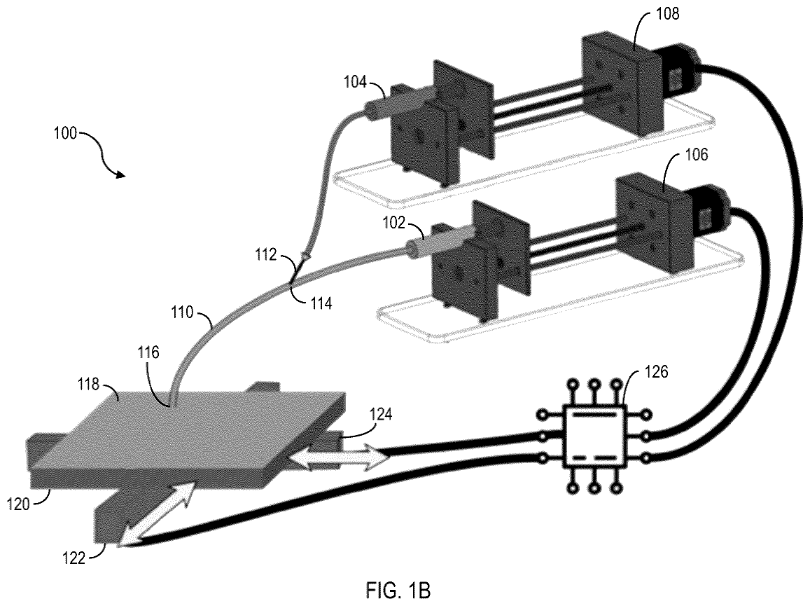

Referring to FIG. 1A, shown therein is a flow diagram of a method 10 for nanothermite aerogel direct ink printing, according to an embodiment. Advantageously, the method 10 does not use polymers in the printable/extrudable ink, rather graphene oxide is reduced to form a 3D scaffold for nanothermite particles in the ink.

At 12, graphene oxide (GO) may be provided or synthesized following a modified Hummer's method as previously described (see, for example, Thiruvengadathan, R., et al., “A Versatile Self-Assembly Approach toward High Performance Nanoenergetic Composite Using Functionalized Graphene,” Langmuir, 30 (2014) 6556-6564 and Wang, A., et al., “Reactive nanoenergetic graphene aerogel synthesized by one-step chemical reduction,” Combust. Flame, 196 (2018) 400-406).

The Hummer's method is summarized as follows: 1 gram each of graphite (Grade H-5) and sodium nitrate (NaNO₃) were added to 46 mL sulfuric acid (H₂SO₄, 95-98%) and stirred for 10 minutes in an ice-water bath. Subsequently, 6 grams of potassium permanganate (KMnO₄) was slowly added to the mixture. The water bath was then heated to 35° C. and kept for one hour to allow oxidation of the graphene to occur. 80 mL of deionized water was then added to the mixture dropwise, followed by heating of the water bath to 90° C. and maintaining it at this temperature for 30 minutes. The mixture was then allowed to cool to room temperature before adding 200 mL deionized water and 6 mL hydrogen peroxide solution (H₂O₂, 30% by weight). The purification process was carried out by repeated centrifugation and dissolution using deionized water until the pH value reached 5. After sonication and final centrifugation, GO sheets were eventually obtained after drying the aqueous solution overnight at 65° C.

At 14, a graphene-nanothermite (GO/Al/Bi₂O₃) ink may be prepared. To prepare the GO/Al/Bi₂O₃ ink, the as-prepared GO (from step 12), fuel nanoparticles (e.g., Al nanoparticles, up to 100 nm in diameter, 83% active), and oxidizer nanoparticles (e.g., Bi₂O₃ up to 120 nm in diameter) are dispersed in propylene carbonate under sonication. After 3 hours, the Al and Bi₂O₃ dispersions are mixed and sonicated for one more hour before mixing with the GO dispersion. The mixture of GO/Al/Bi₂O₃ is then stirred for 5 minutes and left to rest overnight (at least 12 hours) before printing. According to various embodiments, the amounts of GO and fuel/oxidizer nanoparticles used in different ink preparations are listed in Error! Reference source not found..

TABLE 1
Mass amounts of GO, Al, and Bi₂O₃ for the
GO(x %)/Al/Bi₂O₃ ink in 10 mL propylene carbonate.

| GO(x %) | ER | GO | Al | | Bi₂O₃ | |
|---|---|---|---|---|---|---|
| 20% | 1.5 | 100 mg | 69 | mg | 331 | mg |
| 15% | | | 155 | mg | 745 | mg |
| 5% | | | 329 | mg | 1571 | mg |

In Table 1, it is notable that the mass and concentration of GO are maintained constant. The final product rGO(x %)/Al/Bi₂O₃ indicates the gel printed using the GO(x %)/Al/Bi₂O₃ ink since the reduction of GO occurs during the printing process. The percentage value is calculated between the mass of GO and the total mass of GO and nanoparticles. 5-20% GO is preferred, but GO quantity can be dropped to 2% or even lower. The equivalence ratio (ER) is calculated as:

$$ER = \frac{{( {n}_{Al} / {n}_{{Bi}_{2} {O}_{3}} )}_{actual}}{{( {n}_{Al} / {n}_{{Bi}_{2} {O}_{3}} )}_{stoich iometry}}$$

Steps 12 and 14 may be performed in advance of the rest of the method 10 and the GO and the ink that are prepared by those steps may be stored for later use.

At 16, the GO/Al/Bi₂O₃ ink is mixed, in-situ, with a reducing additive (e.g., ethylenediamine) to reduce the GO to rGo at room temperature in an additive manufacturing system, e.g., the printing system 100 shown in FIG. 1B. GO/Al/Bi₂O₃ ink and ethylenediamine are loaded in respective syringes 102, 104 driven by syringe pumps 106, 108. A 1.6 mm (1/16″) diameter polyvinyl chloride (PVC) extrusion tube 110 is connected to the syringe 102 of GO/Al/Bi₂O₃ ink, and a needle 112 is connected to the syringe 104 of ethylenediamine to inject ethylenediamine into the ink in the extrusion tube 110 to initiate a gelation reaction.

Appropriate flow rate and reaction duration in the extrusion tube 110 are critical to the success of the printing. The moving rate of the syringe pumps 106, 108 is adjustable. Preferably, the moving rate of the syringe pumps 106, 108 is set to make the volume ratio between GO/Al/Bi₂O₃ ink and ethylenediamine at 20:1, and the bulk velocity of the material in the tube 110 to be up to 40 mm/s such that a total reaction time is 6 seconds between a location 114 where ethylenediamine is injected into the tube 110 and a tube outlet 116. No extra device was utilized to assist the liquid flow in the tube or the gel extrusion. According to some embodiments, the ratio of ink to reducing additive may be greater than 20:1 (e.g., 30:1). Generally, the amount of reducing additive that is added should be as low as possible to ensure full reduction of the Go to rGO without substantially diluting the ink.

At 18, extruding of the rGO/Al/Bi₂O₃ gel onto a substrate 118 is performed at room temperature. The gelation and in-situ reduction of GO is triggered by injecting ethylenediamine into the extrusion tube 110. That is, steps 16 and 18 are generally performed concurrently. According to an embodiment, the gel is printed onto a 6.1 cm×6.1 cm acrylic plate substrate 118.

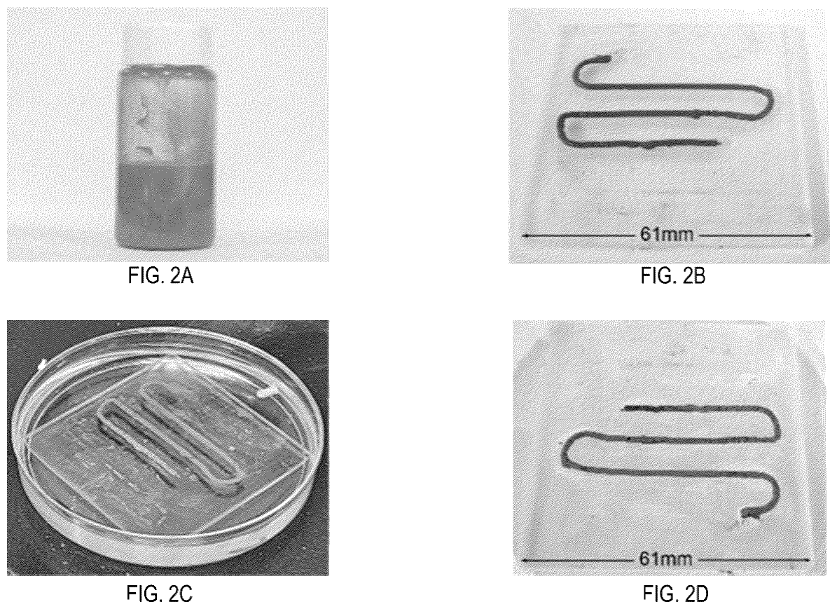

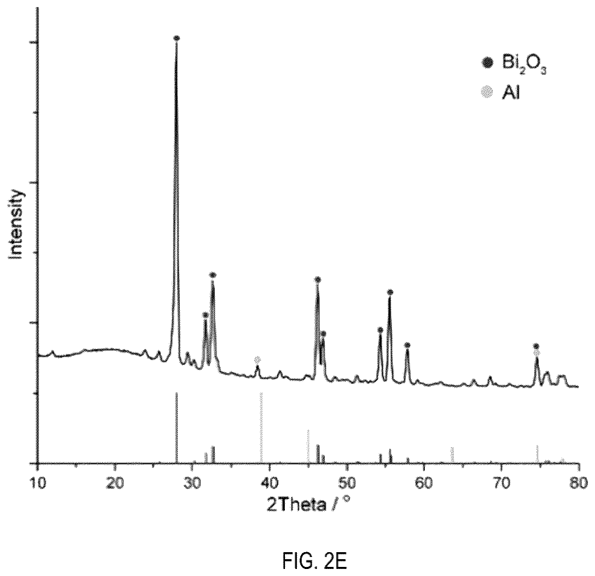

At 20, the substrate 118 is moved in an xy plane while the gel is extruded onto the substrate 118. The substrate 118 is mounted on a stage 120 controlled by xy linear actuators 122, 124. The stage 120 is movable in an xy (horizontal) plane to allow for the gel to be printed on the substrate 118 in a curved line (see FIGS. 2B-2D). A microcontroller 126 (e.g., of a control device) provides input signals to the linear actuators 122, 124 to move the stage 120 in the xy plane. The microcontroller 126 is also connected to the syringe pumps 106, 108 to adjust the moving rate of the syringe pumps 106, 108, thereby controlling the flow rate of the ink and ethylenediamine, respectively.

At 22, after printing, the substrate 118 and the gel thereon is placed into a petri dish and immersed in an alcohol, preferably tert-butanol (99%), under stirring. At 24, the gel is left for 3 days to allow the propylene carbonate and ethylenediamine to be exchanged by the alcohol. The alcohol is renewed every 12 hours.

At 26, after the solvent exchange process, the gel is freeze-dried to obtain a rGO/Al/Bi₂O₃ aerogel.

At 28, the rGO/Al/Bi₂O₃ aerogel, may be cut into pellets. According to other embodiments, the aerogel may be directly formed as energetic materials such as pellets by printing pellets onto the substrate 118 at steps 18 and 20. In other embodiments, the energetic materials may be printed into other desired shapes, using a mold mounted to the stage to shape the energetic materials.

A nanothermite aerogel produced by the method 10 may be used as a fuel source for propulsion or energy generation. Such a fuel source may be particularly advantageous when used as a propellant and combusted in a rocket engine for propulsion. Additionally, such a fuel source may be particularly advantageous in generating energy and or combustion of these materials acting as a heat source for thermal power generation, and or as a thermal source for thermophotovoltaic systems to convert heat to electricity. In other implementations, these fuel sources may be used in combined cooling, heat and power applications.

Referring to FIGS. 2A-2D shown therein are optical images of a nanothermite (rGO/Al/Bi₂O₃) ink/gel at different stages during the printing method 10. GO sheets, Al, and Bi₂O₃ nanoparticles all had negative surface charge in propylene carbonate dispersion. As a result, after mixing and resting overnight, the GO/Al/Bi₂O₃ ink did not show any precipitation, giving a homogeneous dispersion to work with (FIG. 2A). The as-printed rGO/Al/Bi₂O₃ gel with propylene carbonate (FIG. 2B), underwent a solvent change process (FIG. 2C) before being freeze-dried to obtain the final dried rGO/Al/Bi₂O₃ aerogel (FIG. 2D). After freeze-drying, the rGO/Al/Bi₂O₃ aerogel retained its shape.

FIG. 2E shows an X-ray diffraction (XRD) spectrum of the dried aerogel shown in FIG. 2D and the standard spectra of Al and Bi₂O₃. The XRD spectra were performed by PANalytical X'pert Pro MRD and from 10-80° at a step of 0.1° in Grazing Incidence X-ray Diffraction (GI-XRD) mode. Both Al and Bi₂O₃ are found in the final aerogel. The XRD peak of rGO at about 24°, however, is indistinguishable in the XRD curve. This is partly due to the relatively low percentage of GO, but also because of the unique thin-sheet structure of the rGO sheet in the aerogel, as confirmed by SEM images.

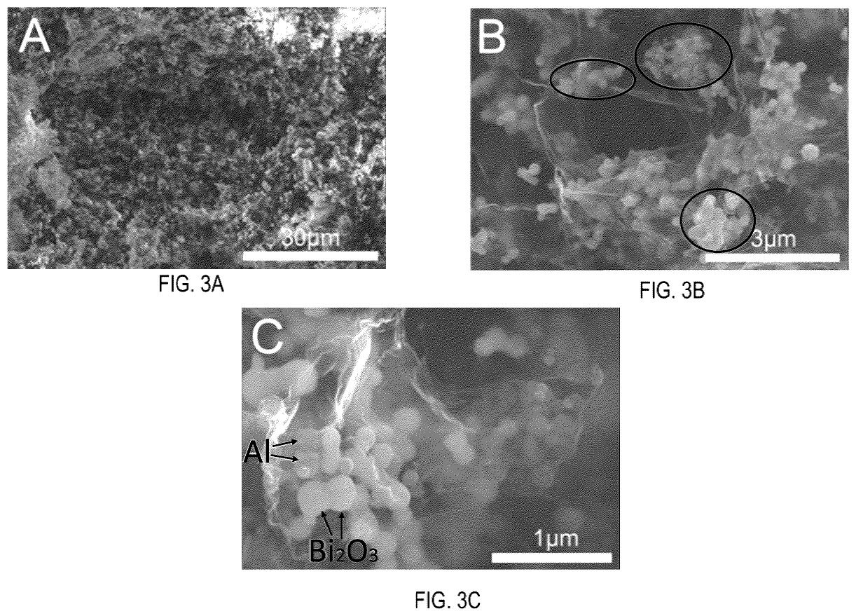

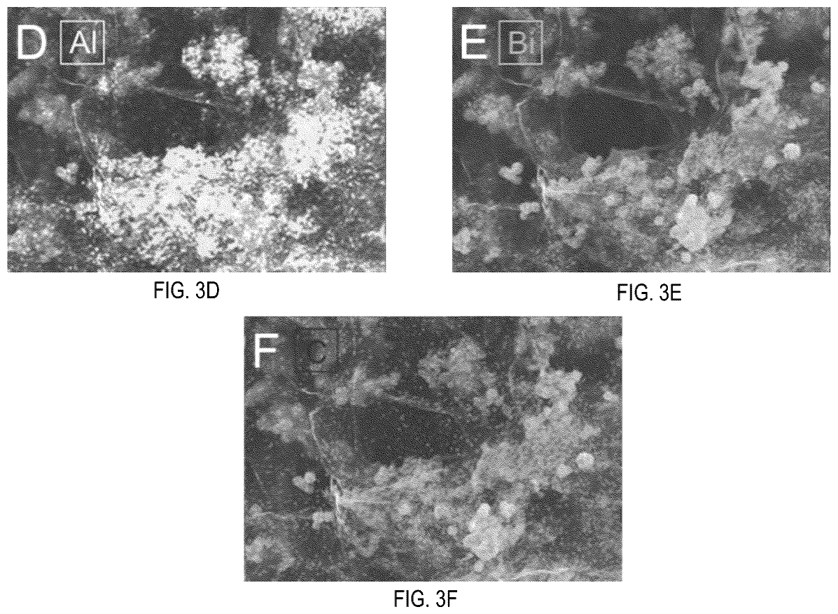

Referring to FIGS. 3A-3C, shown therein are scanning electronic microscope (SEM) images of a printed rGO/Al/Bi₂O₃ aerogel at different magnifications. The microstructure of the gel was observed using a Hitachi Su-5000 SEM and an Oxford EDS (Energy Dispersive Spectroscopy). FIG. 3A gives an overall view of the printed rGO/Al/Bi₂O₃ aerogel, showing a porous structure with nanoparticles embedded across the structure. Zooming in, FIG. 3B shows the pore size on the order of micrometers. The Al and Bi₂O₃ nanoparticles cannot form and hold a self-standing 3-dimensional structure by themselves; it was the rGO sheets that constituted the framework of the 3D aerogel structure. These are shown as the semi-transparent fabric-like sheets in FIGS. 3Error! Reference source not found.B-3C. GO was well dispersed in propylene carbonate into very thin layers in the ink before printing, leading to the formation of such extremely thin rGO layers. After mixing with ethylenediamine in-line, the reduction and interconnection of GO occurred and formed the porous skeleton of the aerogel. Both Al and Bi₂O₃ nanoparticles were covered and wrapped by thin rGO sheets, forming small clusters of nanothermite (circled in FIG. 3B) in the size of a few microns.

Referring to FIGS. 3Error! Reference source not found.D-3F shown therein are elemental mapping of aluminum, bismuth and carbon, respectively, in the image shown in FIG. 3Error! Reference source not found.B. Comparison of FIGS. 3D and 3E indicates a homogeneous distribution of the two different kinds of Al and Bi₂O₃ nanoparticles without any phase separation. Unlike aluminum and bismuth, which are mostly located inside the clusters in the gathered nanoparticles, rGO (carbon, FIG. 3F) is distributed evenly across the aerogel and played the most important role as the supportive structure/scaffold for the Al and Bi₂O₃ nanoparticles.

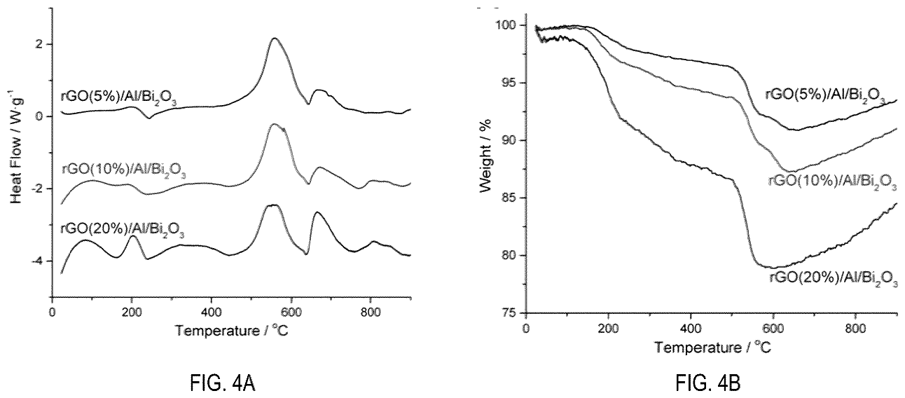

Referring to FIGS. 4A-4B and Table 2, shown therein are differentiative scanning calorimetry (DSC) and thermogravimetric analysis (TGA) showing the heat exchange and mass change, respectively, of various nanothermite aerogels during a slow heating process, according to several embodiments. DSC-TGA was analyzed by a Netzsch STA 449 F1 from room temperature to 1000° C. at a heating rate of 20° C./min under the protection of Argon flow at 40 mL/min.

TABLE 2
Energetic data of rGO/Al/Bi₂O₃ products
from DSC and combustion results.

| Aerogel | Onset | Peak | Energy release | Linear burning | |
|---|---|---|---|---|---|
| Name | Temp. | Temp. | before Al melt | rate* | |
| rGO(20%)/ | 513° C. | 552° C. | 248 ± 42 J/g | 0.39 ± 0.02 | m/s |
| Al/Bi₂O₃ | | | | | |
| rGO(10%)/ | 518° C. | 554° C. | 377 ± 27 J/g | 8.0 ± 0.4 | m/s |
| Al/Bi₂O₃ | | | | | |
| rGO(5%)/ | 516° C. | 558° C. | 415 ± 48 J/g | 10 ± 0.5 | m/s |
| Al/Bi₂O₃ | | | | | |

*The error was estimated by the error of length measurement (±0.5 mm) and time calculation (±0.01 ms).

The exothermic and the subsequent endothermic peaks between 16° and 300° C., as exhibited in the DSC curve in FIG. 4A, resulted from the decomposition of remaining oxygen-containing functional groups in rGO, which corresponded to the weight loss at the same temperature as shown in FIG. 4B. The main reaction between Al and Bi₂O₃ had an onset temperature around 515° C. and a peak temperature around 555° C., much lower than the peak temperature of Al/Bi₂O₃ loose powder at 600° C., due to the proximity between the fuel (Al) and the oxidizer (Bi₂O₃) nanoparticles inside each cluster, as seen in the SEM images (FIGS. 3B-3C).

The exothermic peak after Al melting was caused by the reaction between Al and Bi₂O₃ after Al melted and flowed across the rGO structure. This reduction of the onset temperature indicates an improved reactivity of the printed nanothermite aerogel. Formation of Al/Bi₂O₃ clusters during the 3D printing process is expected to facilitate agglomeration of reactive fuel and oxidizer nanoparticles and subsequently enhance the reactivity. As a “unit cell” the agglomerate is ignited and reacted locally, accompanied with the sintering of the fuel and oxidizer nanoparticles within its volume.

Referring to FIG. 4B, a sharp weight loss occurred at about the same temperature as the main reaction, possibly from the reaction between carbon in rGO and Bi₂O₃. The weight loss increased in the aerogels with higher rGO percentage. It is worth noting that the energy release numbers of rGO(5%)/Al/Bi₂O₃ and rGO(10%)/Al/Bi₂O₃ were quite close, similar to the percentage difference of nanothermite particles in the product. The shape of the DSC curves (FIG. 4A) of these two aerogels were also very similar, with a dominant condensed-phase reaction prior to Al melting and a smaller exothermic peak after. However, the energy release of the condensed-phase reaction of rGO(20%)/Al/Bi₂O₃ was smaller. The decrease was significantly larger than the change of nanoparticle percentage in the material, indicating some difference in structure and reaction when nanoparticle loading was relatively low.

As seen in SEM images (FIGS. 3A-3F), the rGO/Al/Bi₂O₃ aerogel consisted of a cross-linked rGO cage and the wrapped Al/Bi2O3 nanoparticle clusters. Since the concentration of GO in the ink and the ratio between the ink and ethylenediamine were constant between the imaged aerogels, it is reasonable to believe that the degree of cross-linking and the quantity of clusters were close among the aerogels with different nanoparticle loadings. Therefore, the aerogel with lower nanoparticle loading had not only a larger dead mass of rGO, but more importantly, might have smaller Al/Bi₂O₃ agglomerates and interfacial contact between fuel and oxidizer, which led to a much less significant condensed phase reaction in DSC. The total energy release of the aerogels was also low compared to Al/Bi₂O₃ loose powder (around 700 J/g), as a result of the isolated nanoparticle clusters.

To further understand how rGO percentage changes the energetic properties, the aerogels with 5-20% rGO were used to measure their flame propagation rates. The density of the aerogel was estimated from 50-200 mg/cm³, calculated by GO concentration in ink (10 mg/cm³) divided by GO percentage (5-20%), giving a TMD (theoretical mass density) percentage around 1-3%. The combustion of the aerogels was triggered by a nickel-chromium wire (˜100, 4 cm) connected to a DC power supply at 30V. Combustion video (512×320 resolution) was captured at 100,000 frames per second using a Phantom v2012 monochrome fast camera with exposure set to 5 μs and 1 μs (20%) extended dynamic range (EDR) setting. The camera and DC power supply were synchronized using a TTL signal output by a Tektronix AFG1022 arbitrary function generator.

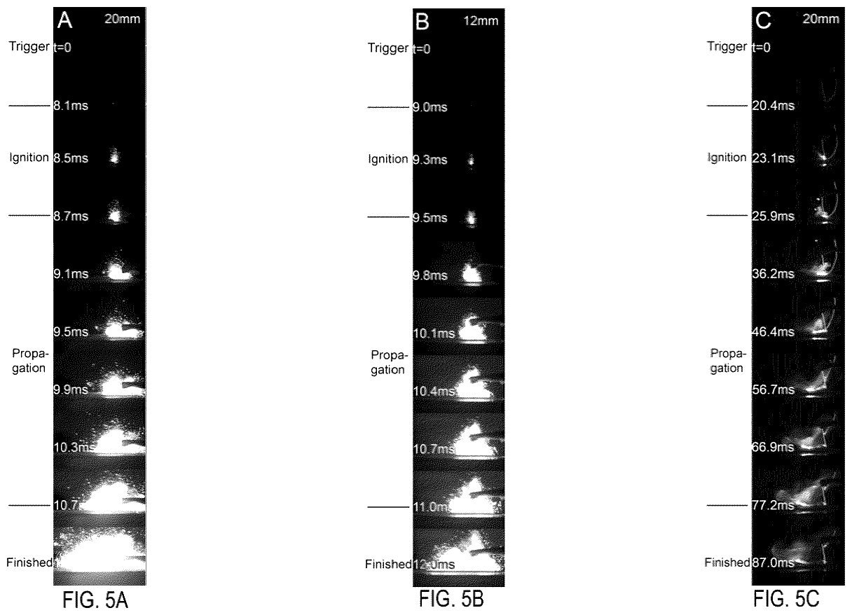

Referring to FIGS. 5A-5C, shown therein are high-speed video frames capturing combustion of nanothermite aerogels, according to several embodiments. The propagation of the combustion went from a right side to a left side for all the aerogels. Similar to the DSC results (FIGS. 4A-4B, Table 2), the rGO(5%)/Al/Bi₂O₃(FIG. 5A) and the rGO(10%)/Al/Bi₂O₃(FIG. 5B) aerogels showed similar results while the rGO(20%)/Al/Bi₂O₃ aerogel (FIG. 5C) behaved differently.

When the nanoparticle loading was no less than 90% (FIGS. 5A and 5B), the reaction was quite violent. The combustion propagated at a higher speed (8-10 m/s) than is typically observed for polymer-assisted 3D-printed nanothermite products (<1.5 m/s) and the high-temperature flame expanded to the surrounding environment due to the unique porous structure and presence of rGO. However, when the nanoparticle loading was reduced to 80% (FIG. 5C), the energy release from the reaction was just barely enough to maintain the self-sustained combustion, giving a flame propagation speed of only 39 cm/s. The rGO residue was even recognizable.

The ignition delays were both around 9 ms for the aerogels with 90% and 95% nanoparticle loading. Therefore, the temperature of the nickel wire can be estimated by:

$$T = {T}_{0} + \frac{Q}{mc} = {T}_{0} + \frac{{V}^{2} t}{R ρπ {r}^{2} Lc} = 22 ° C . + \frac{{( 30 )}^{2} \times 0.009}{10 \times 8.5 \times π \times {( 0.005 )}^{2} \times 4 \times 0.45} ° C . = 696 ° C .$$

This is consistent with the reaction temperature found in DSC results. However, in the aerogel with 80% nanoparticle loading (FIG. 5C), the ignition delay was increased to about 26 ms, allowing the nickel-chromium wire to get visibly hot before the aerogel was ignited. It is anticipated that a high amount of rGO in the printed aerogels not only prevented the formation of larger Al/Bi₂O₃ clusters, but also transferred heat across the aerogel and delayed the initiation energetic reaction.

Combining the TGA/DSC results and the flame speed measurements, it can be concluded the rGO in the printed nanothermite aerogel played multiple roles in the structure, enhancing and diminishing the reaction at the same time. On one hand, the rGO constituted the 3D skeleton for nanoparticles to assemble on and formed a unique porous structure, which helped to accelerate the reaction. By contrast, in polymer-assisted 3D printed nanothermite materials, the polymer in the structure forms a continuous phase, with Al and metal oxide nanoparticles decorating inside the “sea of polymer,” which significantly reduces the direct contact between fuel and oxidizer. Although some polymers used in the 3D printing nanothermite materials are also considered oxidizers (such as fluoropolymer) or explosive (such as nitrocellulose), the slow decomposition step of the polymer is the rate-determining step of the combustion.

However, in the 3D printed rGO/Al/Bi₂O₃ aerogels, there is no polymer and, more importantly, the Al and Bi₂O₃ nanoparticles are tightly packed together into clusters by rGO sheets. As noted above, a sintering mechanism supports the local ignition and combustion of agglomerates in the nanothermite aerogel and formation of clusters consisting of both fuel and oxidizer nanoparticles during printing is expected to facilitate the thermite reaction. Meanwhile, the significantly enhanced surface contact between Al and Bi₂O₃ allows a much faster condensed-phase reaction. Additionally, the micron-sized pores inside the structure allowed the hot combustion product to better propagate inside the structure, leading to the local formation of hot-spots in the scaffold.

The highly thermally conductive rGO also provided an alternative way for heat transfer in low TMD % nanothermite aerogel. On the other hand, when the nanoparticle loading was too low (corresponding to a large rGO percentage), combustion enthalpy per mass from the thermite reaction was less. Added rGO could effectively reduce intimacy between Al and Bi₂O₃ nanoparticles, which reduces reactivity. The thermally conductive rGO scaffold further enhanced the heat loss and hindered the combustion propagation. Therefore, the nanoparticle loading percentage must be higher than a threshold value to guarantee the accelerating effect of rGO in the final aerogel. The number is dependent on multiple parameters, including the topology of the printed aerogel, the properties of the nanothermite materials, and the amount of ethylenediamine used during the reaction. The results shown in FIGS. 4-5 suggest that increasing particle loading past 95% may produce even faster and more energetic combustion, which would however reduce the effects of rGO in forming the localized clusters.

The energetic materials and nanothermite aerogels described herein include Al as the fuel and Bi₂O₃ as the oxidizer, however, those skilled in the art will understand that the other metallic fuel and oxidizer combinations may be possible. For example, the metallic fuel may be Mg, Si, Fe, etc. and the oxidizer may be a fluoropolymer, iodine oxide or a metal oxide (e.g., Fe₂O₃, SiO₂, MgO, etc.). The aerogels described herein may be formed into fuel grains for combustion in solid rocket motors (SRMs). Below, a computational framework to optimize the fuel grain structure to match a desired thrust curve profile is described.

The framework includes two solvers with varying levels of fidelity, to efficiently optimize over a large parameter space. A system-level code (zero-dimension) is first developed to assess the overall behavior of the system. A quasi-one-dimensional code is then developed to incorporate the spatial variation and acoustic modes in the combustion chamber and nozzle for a given functionally-graded engine. Given the complex combustion kinetics of these solid fuel, which remains to a large extent poorly understood, simplified combustion and regression models are used.

### System Level Solver.

A system-level solver is first-developed using isentropic nozzle relations to estimate the vacuum thrust characteristics of the engine. The total thrust of an engine can be estimated based on the total pressure and temperature generated within the combustor for a given nozzle geometry. The equation for vacuum thrust can be recast as:

$${F}_{th , υ ac} = {\frac{{A}_{t} \text{?} ( γ \text{?} + 1 )}{\text{?}} [ ( 2 + \frac{γ - 1}{γ + 1} \text{?} ) ]}^{\frac{γ + 1}{2 ( γ - 1 )}} \qquad [ 1 ]$$

$$\text{?} \text{indicates text missing or illegible when filed}$$

Where P and M are the pressure and Mach number, the subscript e indicates the nozzle exit; Aₜ and γ are respectively the throat area and the specific heat ratio.

The corresponding specific impulse, Isp, is:

$${Isp}_{υ ac} = \frac{{F}_{th} , υ ac}{\dot{m} \text{?} {g}_{0}} \qquad [ 2 ]$$

$$\text{?} \text{indicates text missing or illegible when filed}$$

The 0D model uses isotropic flow equations to relate the combustion chamber state (total pressure and temperature) to the nozzle exit state. In a supersonic nozzle, the mass flow rate is fixed for a given geometry and thermodynamic state of the engine. This allows us to relate the area ratios (exit to throat) to the exit Mach number of the system.

$${( \frac{\text{?}}{{A}_{t}} )}^{2} = {\frac{1}{\text{?}} [ \frac{2}{γ + 1} ( 1 + \frac{γ - 1}{2} \text{?} ) ]}^{\frac{γ + 1}{γ - 1}} \qquad [ 3 ]$$

$$\text{?} \text{indicates text missing or illegible when filed}$$

For a known nozzle geometry (Aₑ/Aₜ), we can compute the exit temperature and pressure knowing the thermodynamic conditions in the engine:

$$\frac{{T}_{comb}}{{T}_{e}} = [ 1 + \frac{\text{?} - 1}{2} \text{?} ] \qquad [ 4 ]$$

$$\frac{{T}_{comb}}{{P}_{e}} = [ 1 + \frac{\text{?} - 1}{2} \text{?} \qquad [ 5 ]$$

$$\text{?} \text{indicates text missing or illegible when filed}$$

These exit states can then be used to compute the exit velocity knowing the exit speed of sound:

$$\text{?} = \sqrt{\text{?} RT ,} = \text{?}$$

$$\text{?} \text{indicates text missing or illegible when filed}$$

Within the combustion chamber, the thermodynamic states are directly tied to the combustion kinetics and regression of the fuel grain. The produced gaseous mass flow rate produced from combustion is computed as:

$${m}_{in} = {ρ}_{prop} {A}_{burn} {r}_{b} \qquad [ 6 ]$$

where the propellant density, ρₚᵣₒₚ, and linear burn rate, r_{b}, are properties of the fuel. The mₒᵤₜ can be computed based on the exit velocity, area, and density which can be found using the above equations.

The pressure in the combustion chamber is then:

$${P}_{comb} = \frac{Δ mR \text{?} - \text{?} {\dot{V}}_{c}}{{V}_{c}} \qquad [ 7 ]$$

$$\text{?} \text{indicates text missing or illegible when filed}$$

where Δm=mᵢₙ−mₒᵤₜ and T_{comb} is assume, to a first order, equal to the adiabatic flame temperature of the propellant. In the above, V_{c} corresponds to the volume of combusted solid propellant. The above equation accounts for the gas generation and area change of the engine.

The simplistic combustion model assumes a constant burn rate r_{b} and solid fuel density, ρₚᵣₒₚ for a given fuel. More generally, the Saint Robert's law can be used to account for the pressure dependence on the linear burn rate:

$$\text{?} = \text{?} \qquad [ 8 ]$$

$$\text{?} \text{indicates text missing or illegible when filed}$$

where b and n are empirically determined. Herein, it is assumed that the burn rate is decoupled from the combustion chamber pressure. That said, the addition of the Saint Robert's law can be easily extended into the present framework. The 0D model also makes use of the ideal rocket equation to find the relationship between altitude and time which will be important for one of the tests cases. Where v is the velocity of the rocket, u is the exit velocity of the combustion gas and m is the total mass off the rocket.

$$\text{?} d υ = - \text{?} \frac{1}{m} dm \qquad [ 9 ]$$

$$\text{?} \text{indicates text missing or illegible when filed}$$

The change in mass of the rocket is related to the mₒᵤₜ computed above.

Quasi-one-dimensional solver.

A quasi-one-dimensional solver is concurrently developed to account for spatial variations in the combustion chamber and nozzle, as well as investigate the acoustic coupling in a functionally-graded engine. The quasi-one-dimensional code solves the one-dimensional Navier-Stokes equations (conservation of mass, momentum, and energy) in the form of:

$$\frac{\partial Q}{\partial t} + \frac{\partial }{\partial x} ( {F}_{i} - {F}_{υ} ) = {S}_{chem} + {S}_{area} \qquad [ 10 ]$$

where the bold terms represents arrays of the form:

$$Q = ( \begin{matrix}ρ \\ ρ u \\ ρ E\end{matrix} ) \qquad [ 11 ]$$

The inviscid and viscous flux terms are defined as:

$${F}_{i} = ( \begin{matrix}ρ u \\ ρ {u}^{2} + p \\ ρ uE + p u\end{matrix} ) {F}_{υ} = ( \begin{matrix}0 \\ \frac{4}{3} μ {\partial }_{x} u \\ λ {\partial }_{x} T\end{matrix} ) \qquad [ 12 ]$$

Where E represents the sum of internal (e) and kinetic (u²/2) energy per unit mass of the fluid. Standard nomenclature is used for all the thermodynamic variables. The first term on the right hand side of Eq. [10] represents the source term:

$${S}_{chem} = ( \begin{matrix}{r}_{b} {A}_{} ( {ρ}_{s} - ρ ) \\ {r}_{b} {A}_{} ( {ρ}_{s} - ρ ) u \\ {r}_{b} {A}_{} ( {ρ}_{s} {C}_{p} {T}_{f} - ρ E )\end{matrix} ) \qquad [ 13 ]$$

where r_{b} is, as previously noted, the linear burn rate, P_{A} is the perimeter per unit area, and ρₛ, Cₚ, and T_{f} are respectively the density, specific heat and adiabatic flame temperature of the solid propellant.

As the area of the combustion chamber is continually changing as the fuel is regressing, the second source term on the RHS of Eq. [10] accounts temporal and spatial variation of area. The source term is defined as:

$${S}_{area} = - Q \frac{\partial ln A}{\partial t} - ρ F * \frac{\partial ln A}{\partial t} \qquad [ 14 ]$$

where F*=[u, u², uhₜ]^{T}, where hₜ is the total specific enthalpy.

The above equations are closed with the ideal gas equation, which given the high temperature of combustion, represents a reasonable assumption despite the combustion chamber high pressure.

The governing equations are implemented into StanShock which is a quasi-one-dimensional framework. The spatial fluxes are computed via a fifth order WENO scheme and the equations are integrated in time with Strang splitting for robustness. The open-source chemical kinetics solver, Cantera, is used to compute the thermodynamics of the system. Similar to the system-level framework, a constant linear burn rate is used to characterize each propellant.

For a given combustion chamber and nozzle geometry, the equations can be advanced and generated thrust can be computed. The thrust of the rocket can be directly computed, by assuming a perfect expansion in the nozzle, as: Fₜₕ=muₑ+(Pₑ−Pₐₜₘ) Aₑ As the equations are integrated in time, and the fuel regresses, the thrust profile curve can be estimated.

For the purpose of the present framework, the design of a functionally-graded solid rocket engine is considered. The functional grading is achieved through the layering of different fuels, as shown in FIG. 1B. The objective of the present framework is to match, via an optimization solution, the fuel grain structure to a given thrust profile or pressure profile depending on the test case.

### Functionally-Graded Engines.

There are several parameters that are known to affect the performance of a SRM. The main parameters being the heat release, gas release, and burn rate of the fuel. The burn rate can be controlled by manipulating several fuel properties such as the chamber pressure, fuel density, fuel porosity, chemical composition, and physical composition. For additively manufactured energetic materials, several aspects of the physical composition may affect the burn rate such propellant loading, extra polymer additives, and binder material. The variation of these parameters can cause the burn rates of solid fuels to range from the order of millimeters per second to hundreds of meters per second. Thus, by layering the different fuel with varying combustion characteristics, a functionally-graded engine can be designed by varying the combustion properties during the burn. Thus, through an optimal fuel layering, a mission-specific thrust profile can be achieved.

### Test Cases.

A framework that can be used for the future conceptual design of functionally-graded solid rocket engines is provided. To illustrate how this framework can be used, three well-defined test cases are presented: a simple, regressive, thrust profile; a complex thrust profile with multiple peaks, as proposed by Federici et al.; and a conceptual case where the total pressure conditions in the engine are tuned for a perfect expansion in the nozzle during ascent. The test cases are illustrated in FIGS. 7A-7C.

Test case 1 (FIG. 7A), corresponds to a regressive profile which is usually achieved by using a complex grain geometry such as a double anchor geometry. Test case 2 (FIG. 7B) is a more complex thrust profile two peaks, which was presented by Federici et al. Finally, the third test case (FIG. 7C) is a conceptual case wherein the burn characteristics of the engine are modified to match a perfectly expanding nozzle flow during ascent. The ideal pressure vs. altitude curve, shown in FIG. 7C, will be converted into a pressure vs. time curve in the optimization of the fuel grain. The ideal rocket equation, as mentioned previously, relates the velocity of the rocket to the mass of the rocket and exit velocity of the combustion gases. Using this information, as the combustion occurs the mass of the rocket, the velocity and the height of the rocket will be calculated—the atmospheric pressure will thus change in time. From this, an ideal exit pressure (that perfectly matches the atmospheric pressure) as a function of time curve is created and optimized for.

### Optimization Framework.

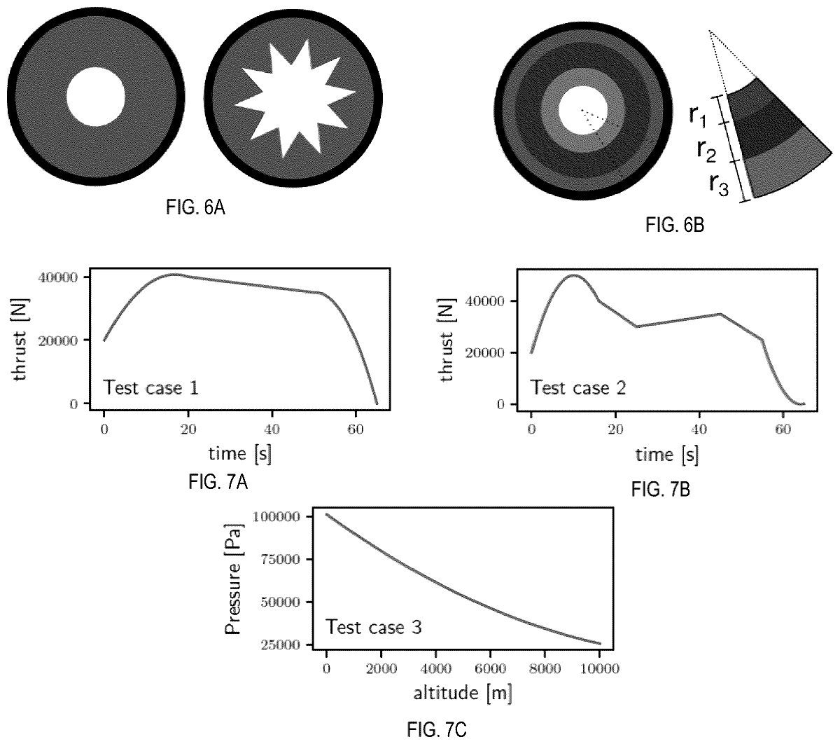

An optimization framework is provided for the conceptual design of functionally-graded solid rocket engines that matches the thrust-time, and pressure-time profiles for a given mission. Given the ability to create functionally-graded engine, the burn rate of the fuel and layer thickness are selected as the independent parameters for the optimization problem. A tubular grain (FIG. 6A, left) is assumed for simplicity. Given the modest parametric space, a brute-force profile matching optimization approach is implemented, although the modularity of the code allows for any constrained optimization algorithm to be implemented. In such a case the constraints are applied to the burn characteristics.

The objective function is defined as minimization of the integrated L2 norm over the entire thrust profile under the geometric and thermodynamic constraints discussed below. The parameters are the layer thickness and the burn rate of each layer. The limits to the fuel layer burn rate is defined as follows:

$$\text{?} 1 \text{?} < \text{?} < \text{?} 1 \text{?} \qquad [ 15 ]$$

$$\text{?} \text{indicates text missing or illegible when filed}$$

where r_{b} is the burn rate. The initial and final radii are determined based on the geometric consideration of the engine. It is assumed in this model that the burn rates are controllable within the predetermined ranges based on the typical burn rates of nanoenergetic material found in literature. The burn rates could also be controlled by parameters such as nanoparticle loading, density, porosity, or pressure. However, these individual factors are not directly accounted for in this model. The density of the fuel is left as a constant for each layer and other tunable effects are neglected. The model also sets a constraint on the number of layers used. A four-layer engine was selected after initial testing of the model as it was effective and computationally efficient. A plurality of layers may be created to enable a user defined combustion profile.

The optimization process starts, in the 0D code, advancing the equation sets in time to determine the burn velocity that will most closely match the thrust, or pressure profile to the sample profile at each time step. At each time step, the ideal burn velocity and the radius at which this occurs is tracked, allowing for an ideal radial distance vs burn rate curve to be plotted.

Once the optimal burn rate at each radial value is known, the fuel regime is broken in to 4 approximate sections which act as the layers within the fuel. The burn rate and thickness of each section are bounded after analyzing the ideal burn rate curve. To aid in the bounding of the burn rates and layer thicknesses, a coarser sample of velocities are used to create a new ideal velocity vs. burn rate curve. A sample of 4 to 5 burn rates are used within the minimum and maximum of the ideal curve. Although less accurate, this can be used to determine the layer properties of the fuel. As the velocity fluctuates between the coarser values, bins are created where the ideal velocity lies. The range of velocity inputs for optimization are bounded by the bin minimum and maximum. The radius input for each layer is bound by the radial position at which the bin value changes ±10% without overlapping the bounds of neighboring layers. The layer properties are optimized within these defined bounds. The size of these layers and their burn rates are then be optimized to best suit the desired thrust or pressure profile.

The optimization of each layer thickness and burn rate is completed using a heuristic approach using a range of random inputs for the layer thickness and burn rate to determine the most accurate solution. The model will save the layer thicknesses and burn rates of the model with the lowest error. The error between the desired profile and the profile generated by the model as the sum of the absolute difference between the two models across all time steps. Finally, the optimized layered solution is passed to the 1D code to assess the spatial variations and acoustics in the engine.

The geometry of the rocket and details of the fuel being used in the model are shown below:
initial radius of the fuel, rᵢ=0.2 m;
final radius of the fuel, r_{f}≤0.6 m;
combustion chamber length, L=5.0 m;
exit area, Aₑ=0.0314 m²;
throat area, Aₜ=0.00314 m²
density of the propellant, ρᵢₙ=900 kg/m³;
adiabatic temperature of combustion, T_{comb}=2900 K; and
initial mass of the system (fuel and rocket), mᵢ=900 kg.

### Test Case 1: Simple Thrust Case

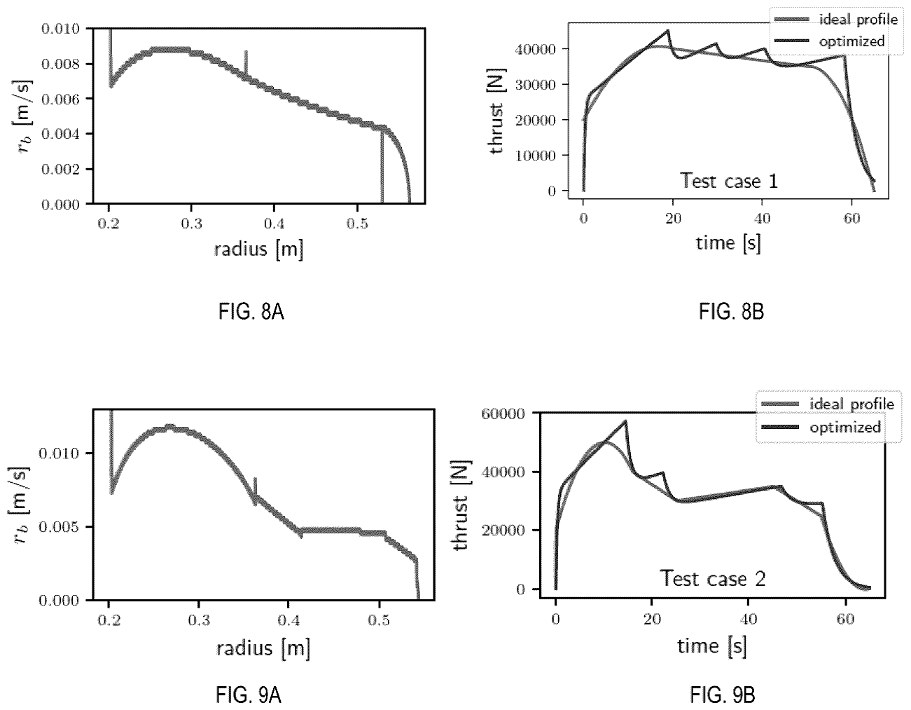

Referring to FIG. 8A, shown therein is an ideal burn velocity profile for simple thrust plotting the ideal burn velocity at each radial distance based on the time step. FIG. 8B shows the optimized solution based on the heuristic method of selecting random burn velocities and layer thicknesses approximated based on the ideal velocities shown in FIG. 8A. It can be seen that there are four distinct layers of fuel before the combustion chamber depressurizes at the end of the launch. The optimal layer thickness, outer radii, and burn velocities for the simple case are shown in Table 3 below.

TABLE 3
Simple Profile Optimal Results

| Layer | Thickness (mm) | Radius (mm) | r_{b} (mm/s) |
|---|---|---|---|
| 1 | 160 | 360 | 8.5 |
| 2 | 70 | 430 | 6.5 |
| 3 | 60 | 490 | 5.5 |
| 4 | 80 | 570 | 4.5 |

For the simple case it can be seen that the layer thickness of the fuel differs as combustion of the fuel progresses. During the initial peak in thrust at the start of the trajectory the thickness of the first layer accounts for 43% of the total fuel radius. Whereas the second, third, and fourth layers of fuel account for 19%, 16%, and 22% of the thickness respectively.

### Test Case 2: Complex Thrust Case.

Referring to FIG. 9A, shown therein is an ideal burn velocity profile for complex thrust plotting the ideal burn velocity at each radial distance based on the time step. FIG. 9B shows the optimized solution based on the heuristic method of selecting random burn velocities and layer thicknesses approximated based on the ideal velocities shown in FIG. 9A. It should be noted that the range of inputs is different from that of the simple case (FIGS. 8A and 8B) as the ranges of values are based on the optimal burn rate at each radius for both models. Due to this, a wider range of inputs were used for the second test case when setting up the optimization trial. It can be seen that with 4 simple layers of fuel with different burn rates, the thrust profile of the modeled SRM can closely match the desired thrust profile of the rocket. The optimal radii and burn velocities for the complex case are shown in Table 4 below.

TABLE 4
Complex Profile Optimal Results

| Layer | Thickness (mm) | Radius (mm) | r_{b} (mm/s) |
|---|---|---|---|
| 1 | 160 | 360 | 11 |
| 2 | 50 | 410 | 6.5 |
| 3 | 110 | 520 | 4.5 |
| 4 | 30 | 550 | 3.5 |

For the complex case it can be seen that the layer thickness of the fuel differs as combustion of the fuel progresses. During the initial peak in thrust at the start of the trajectory the thickness accounts for 46% of the fuel thickness. Whereas the second, third, and fourth layers of fuel account for 14%, 31%, and 9% of the thickness respectively. This is a greater variation in layer thicknesses than the simple case. It is also seen that there is a greater variation in the burn rates for the complex case.

### Test Case 3: Pressure Matching Case.

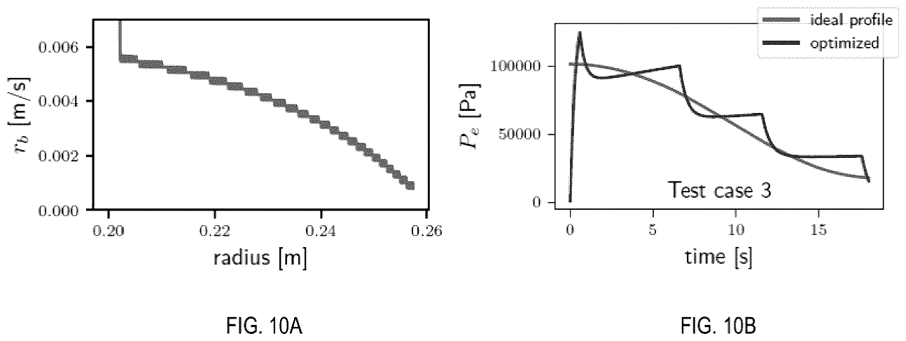

In the third test case, the goal is to match the exhaust pressure of the combustion gas to the atmospheric pressure. Referring to FIG. 10A, shown therein is an ideal burn velocity profile for pressure matching plotting the ideal burn velocity at each radial position. FIG. 10B shows the optimal pressure profile over time using four distinct layers. As mentioned in the test case subsection above, the ideal pressure profile over time is found using the ideal rocket equation and determining the height of the rocket over time based on the mass and gas exit velocity. It can be seen in this case that the exit pressure of the rocket follows the ideal case test fairly well. The optimal burn rates and layer thickness are shown in Table 5 below.

TABLE 5
Pressure Matching Profile Optimal results

| Layer | Thickness (mm) | Radius (mm) | r_{b} (mm/s) |
|---|---|---|---|
| 1 | 5 | 205 | 8.5 |
| 2 | 30 | 235 | 5 |
| 3 | 15 | 250 | 3 |
| 4 | 9 | 259 | 1.5 |

For all three test cases if more layers were to be used, a closer match could be generated by the model. In the future as fuel may be functionally graded, the burn rate could be controlled throughout the fuel to create a more exact SRM. This would cause the optimized profiles to resemble the ideal profiles modeled herein. Using an additive manufacturing process (e.g., a 3D printing method) the material extrusion width may be used as the minimum layer thickness which will lead to more tunable profiles.

In some examples, heterogenous layers of energetic materials (nano- and or micro-thermites) may be utilized at various concentrations to create tunable profiles.

In some examples, novel and flexible thermite-based architected reactive interfaces and structures may be utilized to create tunable two-dimensional and/or three-dimensional structures.

In some examples, mixing and or stirring of materials may be performed using magnetohydrodynamics, using magnets and/or electromagnets.

In some examples, thermite-based architected reactive interfaces and structures may be utilized for heating application. In other examples, interfaces and surfaces may include phase-change material for heating applications and power generation use cases.

In some examples, the thermite-based reactive interfaces and structures may be heated using wireless power transmission. In other examples, wireless power transmission may employ radiative methods (e.g., electromagnetic frequencies such as microwaves and/or lasers) and/or non-radiative methods (inductively-coupled and/or magnetically-coupled)

In some examples, fuels and oxides may be sourced from Earth. In other examples, sources may include recycling space debris, reusing satellites in orbit, or other materials transported from Earth to space. In other examples, metal powders may be sourced from space. Sources may also include in-situ resources utilization such as materials from the Moon (lunar regolith), Mars (martian regolith), and/or asteroid sources.

In some examples, metal powders may be sourced from waste outputs of industrial processes, or products of other combustion processes or waste disposal from human or robotic activity.

In some examples, a spacecraft may transport a plurality of additively manufacturing systems for operations, logistics, maintenance, transportation from point to and or orbit raising.

In some examples, thermite-based interfaces and structures may be embedded into satellites and/or space systems to support space debris removal and/or remediation effort.

In other examples, larger energetic particles and or microthermites may be introduced to layers to tune the combustion profile.

While the above description provides examples of one or more apparatus, methods, or systems, it will be appreciated that other apparatus, methods, or systems may be within the scope of the claims as interpreted by one of skill in the art.

1. A method for additive manufacturing energetic particles, comprising:
in-situ mixing a printable ink comprising energetic particles and graphene oxide, with an additive for reducing the graphene oxide, in an extrusion tube to form a gel;
extruding the gel onto a substrate;
immersing the substrate and the gel thereon into alcohol under stirring; and
freeze drying the gel to form an aerogel.

2. The method of claim 1, further comprising moving the substrate in a horizontal plane while extruding the gel onto the substrate.

3. The methods of claim 1, further comprising varying respective types and concentrations of the energetic particles and the graphene oxide in the printable ink.

4. The method of claim 1, further comprising cutting the aerogel into pellets.

5. The method of claim 1, further comprising preparing the printable ink by:
separately dispersing each of the graphene oxide, fuel nanoparticles and oxidizer nanoparticles in propylene carbonate for 3 hours under sonication;
sonicating a dispersion of the fuel nanoparticles and a dispersion of the oxidizer nanoparticles for 1 hour under sonication;
mixing the dispersion of the fuel nanoparticles and the dispersion of the oxidizer nanoparticles with a dispersion of the graphene oxide for 5 minutes with stirring; and
resting a resultant mixture for at least 12 hours.

6. The method of claim 1, further comprising synthesizing the graphene oxide by:
forming a solution of 1 gram each of grade H-5 graphite and sodium nitrate in 46 mL sulfuric acid;
stirring the solution for 10 minutes in an ice-water bath;
adding 6 grams of potassium permanganate to the solution;
heating the solution to 35° C. for 1 hour;
adding, dropwise, 80 mL deionized water to the solution;
heating the solution to 90° C. for 30 minutes;
cooling the solution to room temperature;
adding deionized water and 30% hydrogen peroxide to the solution until a pH of 5 is reached;
sonicating and centrifuging the solution; and
drying the solution at 65° C.

7. The method of claim 1, wherein the in-situ mixing comprises:
injecting the additive into the extrusion tube containing the printable ink at room temperature.

8. The method of claim 1, further comprising adjusting a material flow rate in the extrusion tube to 40 mm/s such that a total in-situ mixing time is 6 seconds.

9. The method of claim 1, further comprising renewing the alcohol every 12 hours for 3 days.

10. The method of claim 1, wherein the alcohol is tert-butanol.

11. The method of claim 1, wherein the additive is at least one of ethylenediamine and butanediamine.

12. (canceled)

13. An additive manufacturing system, comprising:
a first syringe containing a printable ink, the ink comprising graphene oxide;
a second syringe containing an additive for reducing the graphene oxide;
adjustable syringe pumps for driving the first syringe and the second syringe;
an extrusion tube connected to the first syringe, the extrusion tube having an outlet for extruding the ink onto a substrate;
a needle connected to the second syringe, for injecting the additive into the extrusion tube at a location between the first syringe and the outlet;
a stage for mounting the substrate; and
two linear actuators for moving the stage in a horizontal plane;

14. The additive manufacturing system of claim 13, further comprising a microcontroller for adjusting a moving rate of the syringe pumps and providing input signals to the linear actuators.

15. The additive manufacturing system of claim 13, wherein the substrate is an acrylic plate.

16. The additive manufacturing system of claim 13, wherein the extrusion tube is constructed of a tube of polyvinyl chloride 1.6 mm in diameter.

17. A nanothermite aerogel, comprising:
a porous cross-linked scaffold of reduced graphene oxide; and
a plurality of nanothermite clusters embedded in the porous scaffold.

18. The nanothermite aerogel of claim 17, wherein the nanothermite clusters comprise:
fuel nanoparticles and oxidizer nanoparticles.

19. The nanothermite aerogel of claim 18, wherein the fuel nanoparticles consist of aluminum nanoparticles up to 100 nm in diameter.

20. The nanothermite aerogel of claim 18, wherein the oxidizer nanoparticles consist of bismuth oxide (Bi₂O₃) nanoparticles up to 120 nm in diameter.

21. The nanothermite aerogel of claim 17, wherein the reduced graphene oxide is in 5-20% w/w and the plurality of nanothermite clusters is in 80-95% w/w.

22-25. (canceled)
